(19) United States
(12) Patent Application Publication
(10) Pub. No.: US 2019/0036935 A1
(43) Pub. Date: Jan. 31, 2019

(54) AUTOMATED CERTIFICATION BASED ON ROLE

(71) Applicant: Wurldtech Security Technologies, Vancouver (CA)

(72) Inventors: Nathan John Walter Kube, Vancouver (CA); Dennis Holstein, Seal Beach, CA (US); Gabriel Faifman, Richmond (CA)

(21) Appl. No.: 15/898,159

(22) Filed: Feb. 15, 2018

Related U.S. Application Data
(63) Continuation of application No. 13/644,372, filed on Oct. 4, 2012, now abandoned.

(51) Int. Cl. H04L 29/06

(52) U.S. Cl. CPC H04L 63/102

(57) ABSTRACT

In one aspect, systems and methods for generating a set of certification requirements based on a defined role and certification level for a requesting entity are provided. A target set of certification requirements is organized according to a set of process areas that are applicable to one or more roles. Each process area is defined into a set of process area subgroups, which is further defined according to base practice objectives. Each base practice objective includes an identification of certification requirements. Each of the certification requirements may be applicable to a requesting entity based on the specified level of certification. In another aspect, an entity may request certification based on an evaluation of certification information submitted by the entity against a set of previously determined applicable certification requirements. The certification authority can utilize a variety of thresholds to determine whether certification is appropriate or what level of certification is appropriate.

### CROSS-REFERENCE TO RELATED APPLICATION

This application is a continuation of U.S. patent application Ser. No. 13/644,372, entitled TOMATED CERTIFICATION BASED ON ROLE, and filed Oct. 4, 2012, the entirety of which is incorporated by reference herein.

### BACKGROUND

Generally described, computing devices can be utilized in a variety of contexts such as for exchanging information, facilitating communication between users, facilitating the operation and control of a wide variety devices and processes, and the like. In the context of a manufacturing or production environment, a computing network made up of a number of computing devices, including personal computing devices, server computing devices, programmable logic controllers (PLCs), or other networked devices. The computing network can be utilized in conjunction with a communication network, such as the Internet, to facilitate the operation and control of various devices/processes. For example, a networked PLC may be utilized to control the operation of physical manufacturing or processing equipment, such as controllers for valves, power supplies, pumps, machinery, etc. Similarly, a software application, or suite of software applications, may be hosted on a networked computing device (such as a server or personal computing device) to receive instructions regarding the operation of various equipment and transmit the appropriate respective instructions to the appropriate equipment (such as through a PLC).

A fault in one or more networked computing devices, such a fault in a computing device, can lead to the failure of associated equipment, loss of manufacturing/production time, property damage, and the like. Accordingly, manufacturing/production computing networks (including hardware and software aspects) can be designed with redundant components to avoid fault conditions during execution in a manufacturing/production environment. For example, a PLC may include a “fail safe” mode such that in the event of a fault, the outputs from the PLC mitigate potential damage to attached equipment or errant instructions that could cause additional faults/damage.

Generally described, the equipment in any physical location may be provided or maintained by a number of different entities, such as vendors, integrators, service providers, and the like. Each of the entities can have a different role in the installation, configuration, operation or maintenance of equipment. From the perspective of a facility owner or manager, each entity associated with the equipment should have appropriate certification of compliance with security, engineering best practices, or operational criteria based on their respective role in the process. From the perspective of the entities, role-based certification can allow for additional business opportunities or provide an opportunity to interact with other certified entities. For example, a certified integrator may only wish to utilize certified vendors.

### BRIEF DESCRIPTION OF THE DRAWINGS

The present disclosure will now be described in detail below in connection with the following figures in which:

FIG. 1 is a block diagram of a certification environment including a certification authority and a number of vendors, integrators and service providers;

FIG. 2A is block diagram of the certification system of FIG. 1 illustrating the generation of certification requirements responsive to a request from an entity;

FIG. 2B is a block diagram of the certification system of FIG. 1 illustrating the generation of a certification results responsive to a request from an entity;

FIGS. 3A and 3B are block diagrams illustrative of a data model for organizing certification requirements according to process areas, process area subgroups, and base practice objectives;

FIGS. 4A and 4B are flow diagrams illustrative of a certification scope generation routine implemented by a certification authority;

FIGS. 5A and 5B are flow diagrams illustrative of a certification requirements sub-routine implemented by a certification authority;

FIGS. 6A and 6B are flow diagrams illustrative of a certification scope generation routine implemented by a certification authority; and

FIG. 7 is a flow diagram illustrative of a process area requirements analysis sub-routine implemented by a certification authority.

### DETAILED DESCRIPTION

This disclosure generally relates to the certification of entities based on satisfaction of certification requirements. More specifically, in one aspect, the present disclosure relates to systems and methods for generating a set of certification requirements based on a defined role and certification level for a requesting entity. A target set of certification requirements is organized according to a set of process areas that are applicable to one or more roles. Each process area is defined into a set of process area subgroups, which is further defined according to base practice objectives. Each base practice objective includes an identification of certification requirements. Each of the certification requirements may be applicable to a requesting entity based on the specified level of certification. For a defined role and certification level, an iterative process can be implemented to determine applicable process areas, process area subgroups, and business practice objectives. Based on the applicable process areas, process area subgroups and business practice objective, a set of applicable certification requirements can be determined.

In another aspect, an entity may request certification based on an evaluation of certification information submitted by the entity against a set of previously determined applicable certification requirements. Illustratively, the evaluation of the certification information can include a determination of how many certification requirements have been satisfied, how many certification requirements have not been satisfied but may be satisfied within a time window and how many certification requirements are determined to be not satisfied. The certification authority can utilize a variety of thresholds to determine whether certification is appropriate or what level of certification is appropriate.

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Likewise, although the present application will be described with regard to specific examples, such as roles and process areas, such examples should not be construed as limiting. Accordingly, additional or alternative embodiments may be practiced in accordance with the present application. Furthermore, embodiments of the invention may include several novel features, no single one of which is solely responsible for its desirable attributes or which is essential to practicing the inventions herein described.

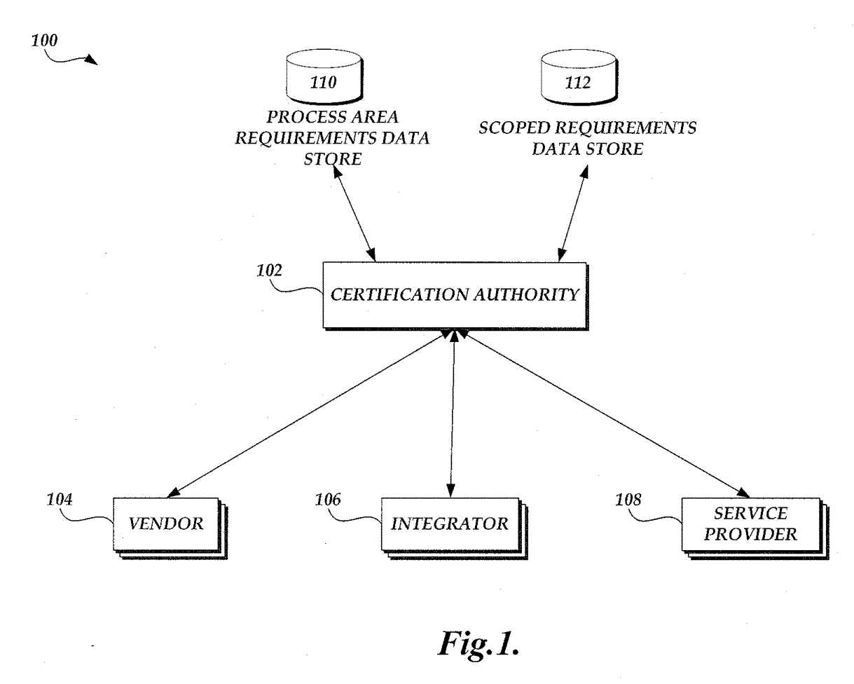

FIG. 1 is a block diagram of a certification environment 100 for illustration of various certification processes of the present application. The certification environment 100 includes a certification authority 102. In communication with the certification authority 102 are a number of entities that are capable of requesting certification. As illustrated in FIG. 1, the entities can be organized according to roles, such as vendors 104, integrators 106 and service providers 108. Although the certification authority 102, vendor 104, integrator 106 and service provider 108 as illustrated in FIG. 1 single components, one skilled in the relevant art will appreciate that the components may entitle a number of identifiable aspects including but not limited to one or more computing devices, networking equipment and personnel. Accordingly, the actions attributed to each of the components should not be limited to any particular type of action or specifically to a type of component.

In some embodiments, one or more aspects of the interaction of the components of the certification environment 100 may be implemented with the transmission or exchange of communications via a communication network, such as the Internet. In such embodiments, the components would utilize one or more computing devices or communication equipment to facilitate the illustrated interaction. In other embodiments, combination of interaction including manual implementation of one or more steps or processes may be implemented.

With continued reference to FIG. 1, the certification authority 102 may maintain, or otherwise be in communication with, a number of data stores for maintaining information associated with the determination of certification requirements by the certification authority or the maintenance of determined certification requirements for future analysis. In one embodiment, the certification authority may maintain a process areas requirement data store 110 maintains information related to the organization of a target set of certification requirements according to a set of defined process areas. In another embodiment, the certification authority 102 maintains a scoped requirements data store 112 for maintaining information related to a selection of certification requirements for one or more entities. Although the process areas requirement data store 110 and the scoped requirements data store 112 are illustrated as single data stores, one skilled in the relevant art will appreciate that data associated with the data stores may be maintained in various data stores or distributed over a computer network.

As previously discussed, in an illustrative embodiment, in one aspect, the certification authority 102 can generate a set of certification requirements from a target set of certification requirements. To generate the target set of certification requirements, the certification authority 102 can first determine which of the target certification requirements may be applicable to the requesting entity based on a designated role. Illustratively, the roles can include a vendor of equipment (e.g., a vendor), an integrator of one or more vendor equipment (e.g., an integrator), or a service provider that configures or maintains installed equipment (e.g., a service provider). A single entity may correspond to one or more roles.

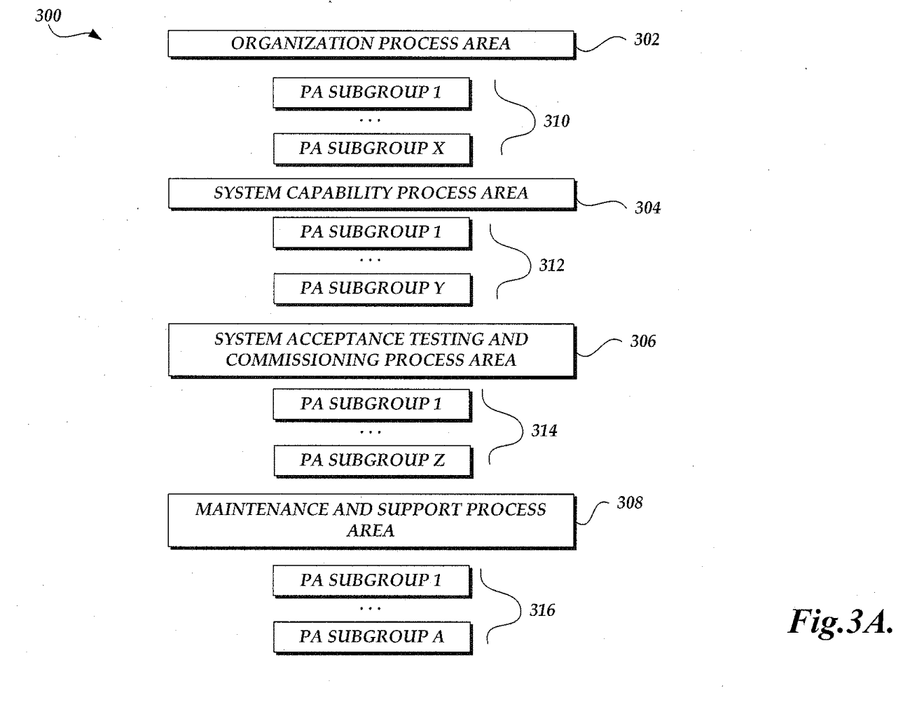

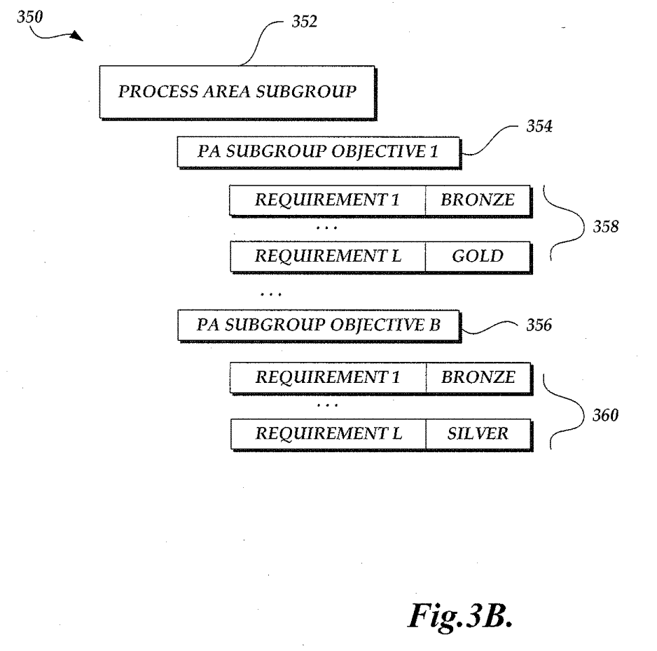

Once the target set of certification requirements has been filtered based on specified role, the certification authority 102 can then select certification requirements base on a specified level of certification. In one embodiment, the levels of certification can be hierarchically arranged. For example, a three level hierarchy may have a first, second and third level (e.g., a bronze, silver and gold level) in which the first level defines the minimal set of certification requirements, the second level incorporates all the certification requirements of the first level plus additional certification requirements and the third level incorporates the certification requirements of the first and second levels plus further certification requirements. In another embodiment, the certification requirements from each of the levels may be defined such that none of the certification requirements overlap between levels. Although the present discussion is described with regard to a three-level hierarchy, one skilled in the relevant art will appreciate that more or less levels of certification requirements may be incorporated. An illustrated data organization model for the target set of certification requirements will be described with regard to FIGS. 3A and 3B.

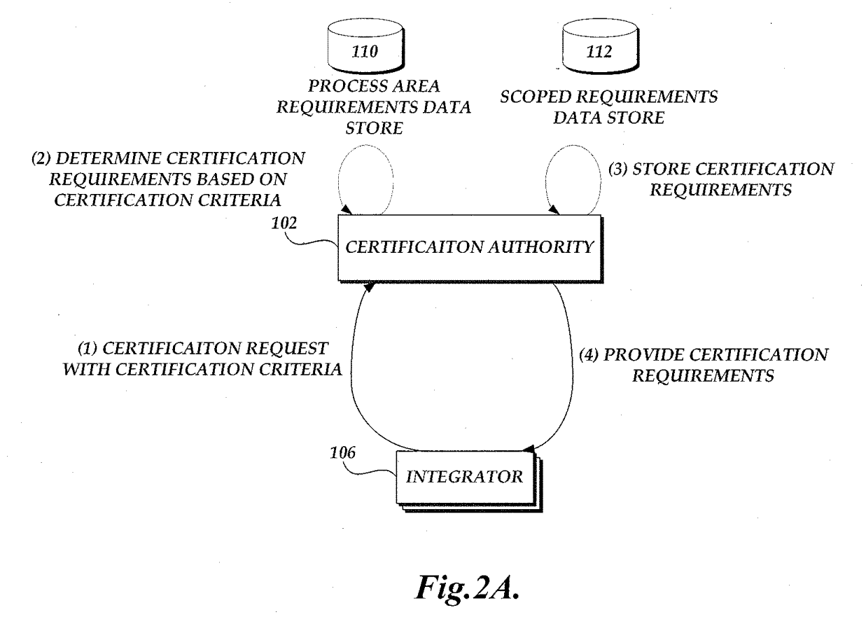

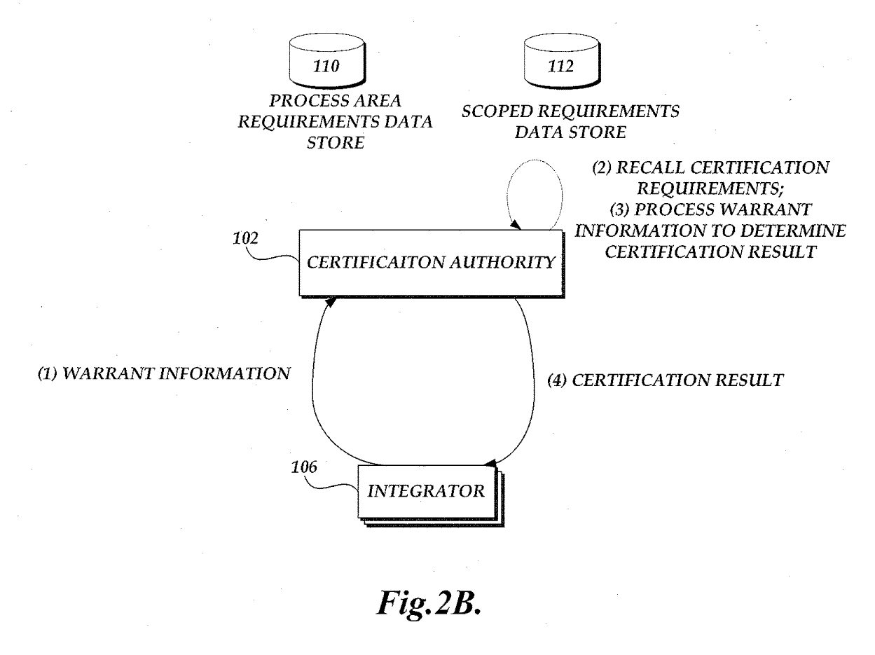

With reference to FIGS. 2A and 2B, various interactions of the components of the certification environment 100 will be described. With reference to FIG. 2A, an illustrative interaction for the generation of a set of requirements responsive to a request will be illustrated. In the example illustrated in FIGS. 2A and 2B, the process will be illustrated with regard to requests from an integrator 106. However, the identification of an integrator 106 is only for illustrative purposes and other roles would be equally applicable. At (1), the integrator sends a certification request to the certification authority 102. Illustratively, the certification request will specify the role of the entity (e.g., an integrator) and a desired certification level.

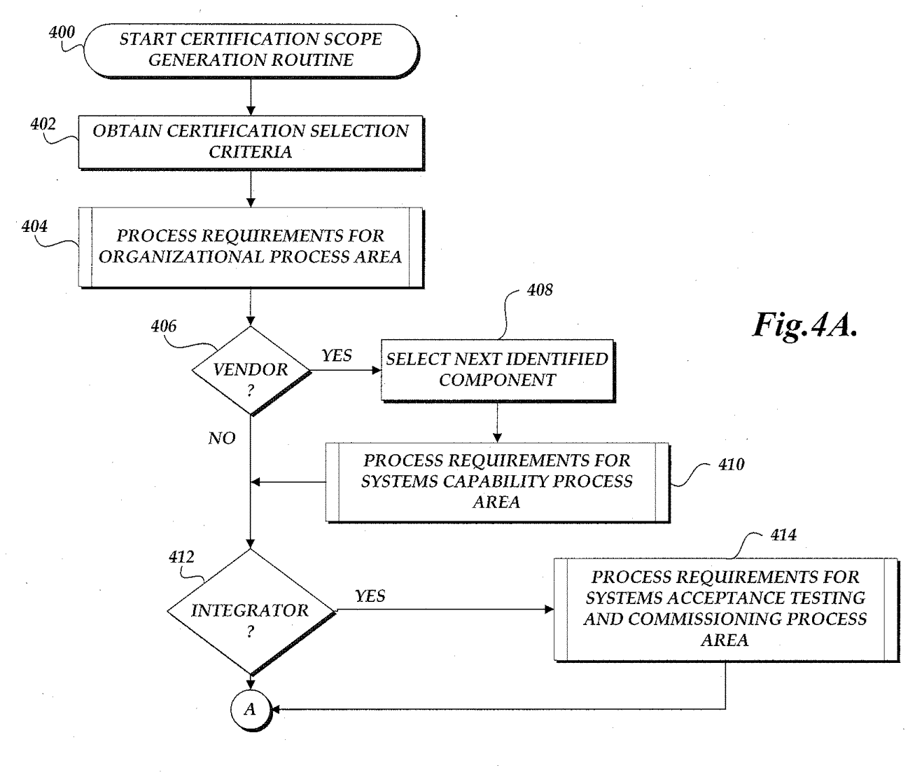

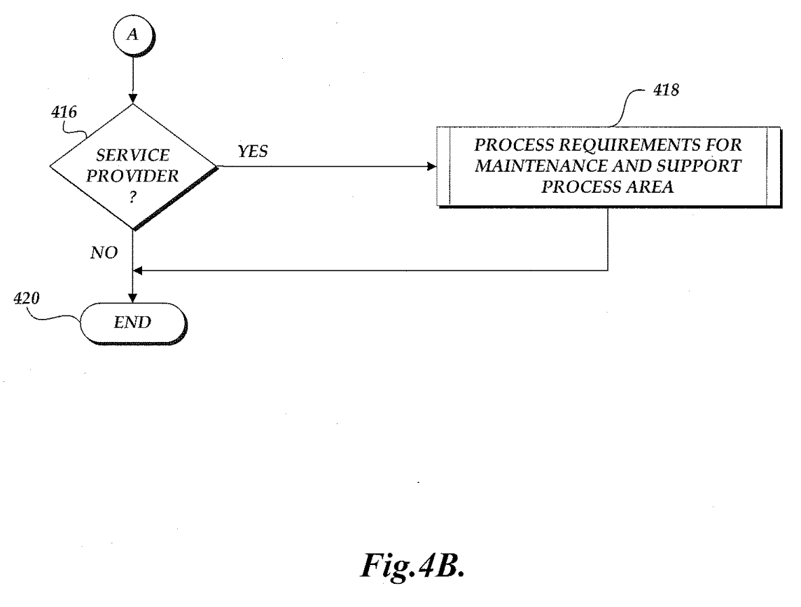

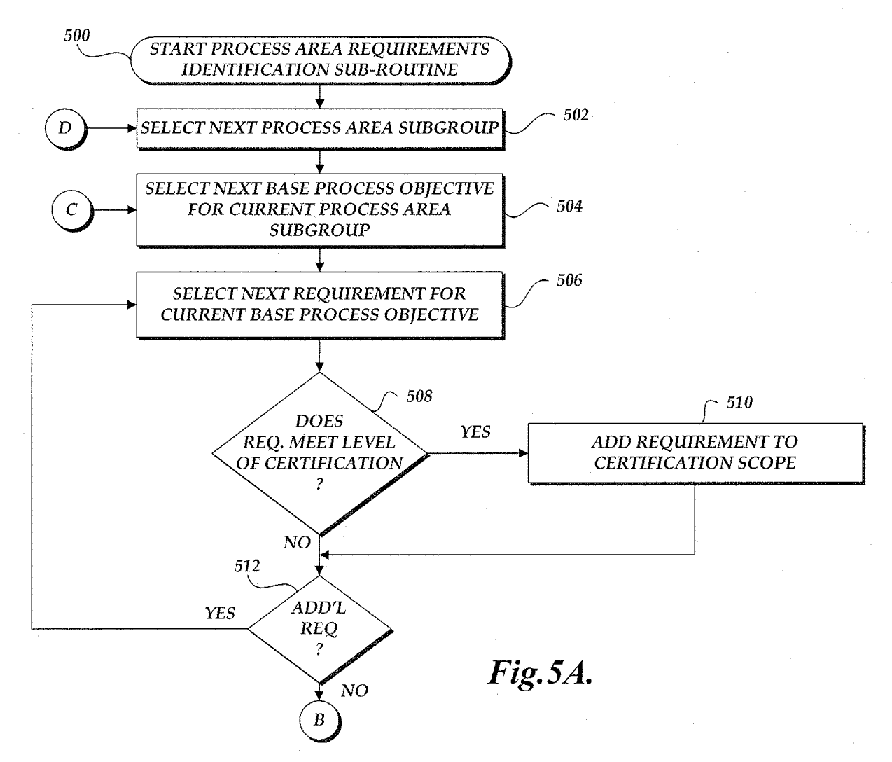

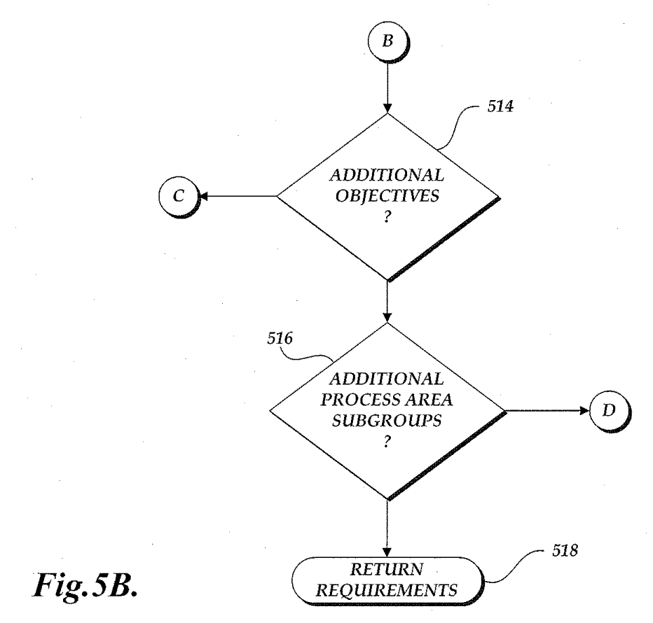

At (2), the certification authority 102 processes the request and determines certification requirements for the requesting entity based on the role of the entity and the desired certification level. Illustrative flow diagrams for processing the certification request will be described with regard to FIGS. 4 and 5. At (3), the certification authority 102 stores the determined certification requirements, such as in the scope requirements data store 112.

At (4), the certification authority sends the determine certification requirements to the requesting entity, integrator 106. The certification authority can publish the certification requirements or utilize various transmission mediums and protocols to send the information. Additionally, the certification authority 102 can also send information utilized to collect certification information or explanatory information.

Turning to FIG. 2B, an illustrative interaction for the evaluation of a set of requirements responsive will be illustrated. At (1), the integrator (or other requesting entity) sends a certification evaluation request to the certification authority 102. Illustratively, the certification request will specify the set of requirements that were previously provided by the certification authority 102 or include the set of certification requirements provided by the certification authority 102.

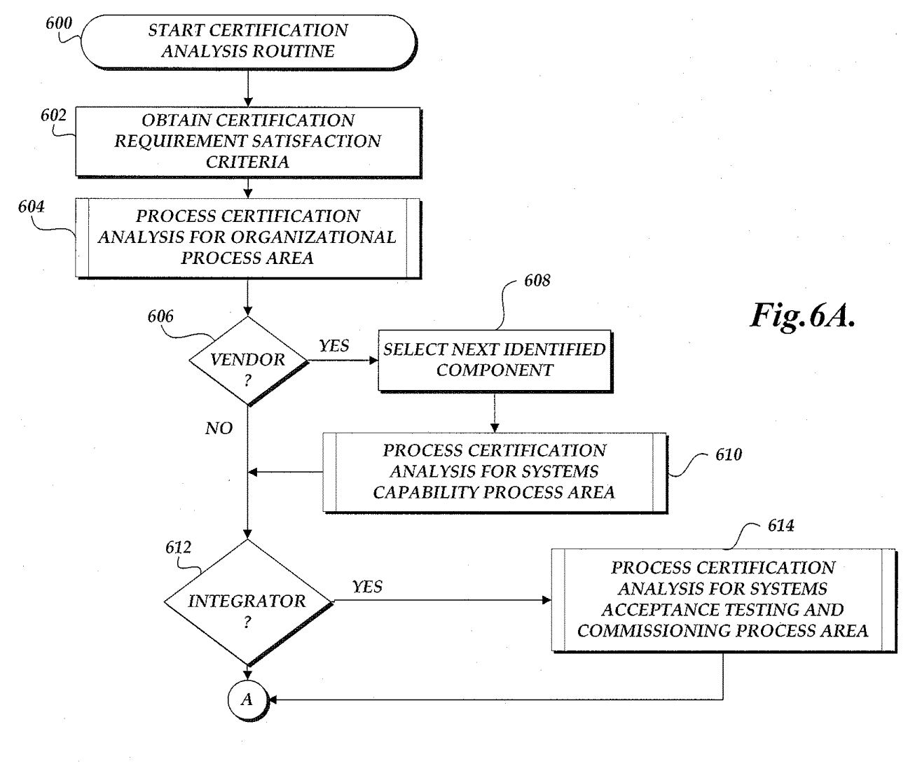

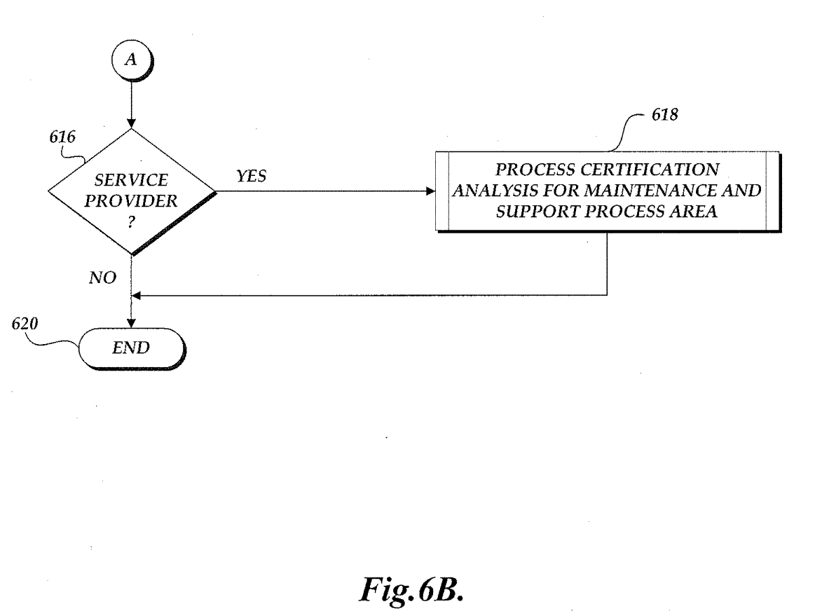

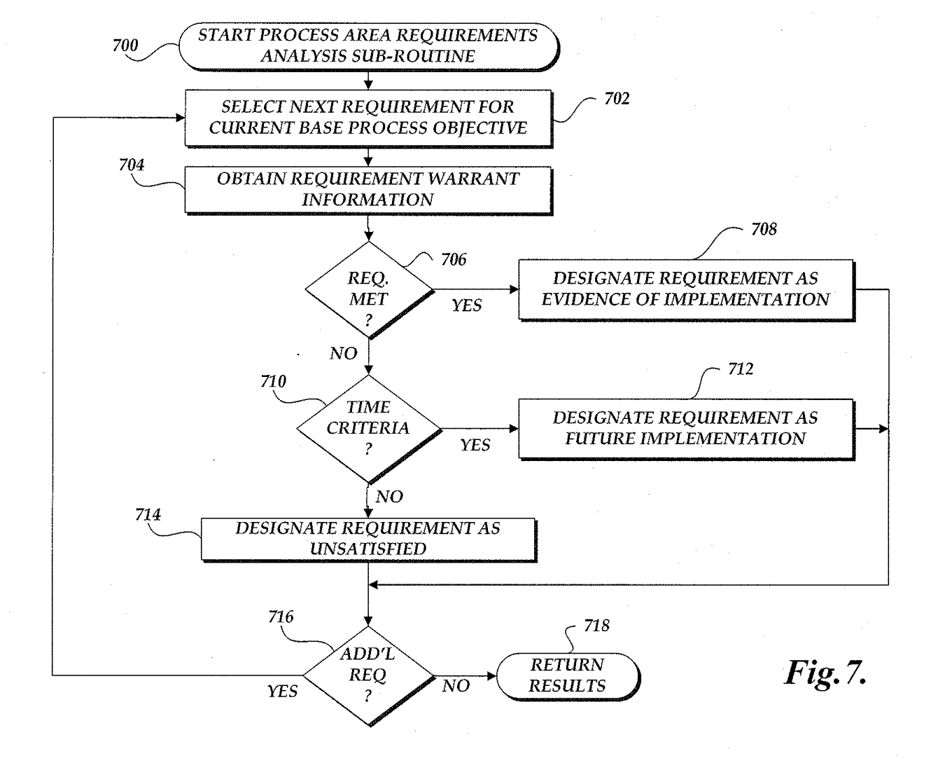

At (2), the certification authority 102 recalls any previously stored information related to the certification requirements previously determined for the requesting entity. At (3), the certification authority 102 processes the request/transmission and determines whether the certification requirements for the requesting entity based on the role of the entity and the desired certification level have been satisfied. Illustrative flow diagrams for processing the certification request will be described with regard to FIGS. 6 and 7. Illustratively, the certification authority 102 can determine whether evidence of implementation, such as warrants that specific actions or configurations are in place, correspond to sufficient evidence of implementation. The certification authority 102 can also identify whether one or more requirements have not been satisfied but may be implemented in the future, as will be described later. Illustratively, the certification authority 102 can utilize a number of thresholds that can specify a maximum number of certification requirements that have not been met, a maximum number of certification requirements that will be implemented in the future or a minimum number of certification requirements that have been implemented to determine whether the requesting entity has satisfied the certification requirements.

At (4), the certification authority sends the determine certification to the requesting entity, integrator 106. The certification authority can publish the certification or utilize various transmission mediums and protocols to send the information. Additionally, the certification authority 102 can also send information utilized to collect certification information or explanatory information.

As previously described, the target set of certification requirements may be organized in a manner that allows the certification authority 102 to filter based on a designated role of the requester. In one embodiment, the organization of the target set of certification requirements corresponds to two or more process areas. With reference now to FIGS. 3A and 3B, an illustrative data model 300 for the set of target certification requirements will be described. With reference to FIG. 3A, the data model includes four process areas 302, 304, 306, and 308 that are selected based on specific functions or processes that may be controlled by the requesting entity. The first process area 302 corresponds to an organization process area and is applicable to every role. The second process area 304 corresponds to a system capabilities process area and corresponds to a vendor role. The third process area 306 corresponds to system acceptance testing and commissioning process area and corresponds to an integrator role. The fourth process area 308 corresponds to a maintenance and support process area and corresponds to a service provider role.

Each process area 302, 304, 306, 308 includes a grouping of process area subgroups 310, 312, 314, 316. The process area subgroups 310, 312, 314, 316 correspond to a further definition of the process area. With reference now to FIG. 3B, each process area subgroup, generically 352, is further defined by one or more process area subgroup are base practice objectives 354, 356 that are fulfilled to meet the definition of the process area subgroup. Each base practice objective 354, 356 then define one or more certification requirements 358, 360 that are to be met to satisfy the base practice objective. As illustrated in FIG. 3A, each of the certification requirements 358, 360 is associated with a certification level that allows the certification authority 102 to determine if the certification requirement is applicable to the requesting entity based on a designated certification level. By way of illustrative example, in a hierarchical certification level embodiment, an entity requesting a “bronze” level certification would only have to satisfy any certification requirements associated with the bronze level. However, an entity requesting a “gold” level certification would have to satisfy all certification requirements including all bronze, silver and gold levels. As illustrated in FIG. 3B, the certification requirements are associated with individual certification requirements under the base practice objectives 354, 356 but the base practice objectives (or other higher organizational components) are not associated with individual certification requirements.

Although the data model 300 has been described with illustrative four process areas, one skilled in the art will appreciate that additional or alternative process areas, process area subgroups, or base practice objectives may be incorporated by the certification authority 10. Appendix A includes an identification of process areas and process area subgroups in an illustrative embodiment. In other embodiments, the certification authority may implement a modified data model or alternative data models.

Turning now to FIGS. 4 and 5, illustrative routines 400, 500 for the generation of a set of certification requirements from a target set of certification requirements will be described. For illustrative purposes, routines 400, 500 will be described as being implemented generally by the certification authority 102 regardless of whether such implementation may involve multiple components associated with the certification authority. With reference to FIG. 4A, at block 402, the certification authority 102 obtains certification selection criteria. Illustratively, an entity, such as a potential vendor 104, integrator 106 or service provider 108, sends a certification request to the certification authority 102. Illustratively, the certification criteria included in the request will specify the role of the entity (e.g., a vendor) and a desired certification level (e.g. silver).

Upon receipt of the request, the certification authority 102 processes the request and determines certification requirements for the requesting entity based on the role of the entity and the desired certification level. In the embodiment illustrated in FIGS. 4A and 4B, the certification authority 102 can implement an iterative process to select appropriate certification requirements based on role and certification level. More specifically, at block 404, the certification authority 102 processes certification requirements for the organization process area 302 (FIG. 3A). As previously described, the organization process area may be applicable to all roles. An illustrative sub-routine 500 for processing the requirements according to a specific process area will be described with regard to FIGS. 5A and 5B.

At decision block 406, a test is conducted to determine whether the designated role corresponds to a vendor role 104. If the role of the requester is a vendor, the certification authority 102 will identify certification requirements for each component to be provided by the vendor. Accordingly, the certification authority 102 enters an iterative loop to select a next component at block 408 and process the certification requirements for systems capability process area 304 (FIG. 3A), which is applicable to for entities that are in a vendor role. Blocks 408 and 410 will repeat for multiple components.

At decision block 412, a test is conducted to determine whether the designated role corresponds to an integrator role 106. If the role of the requester is an integrator, the certification authority 102 will process the certification requirements for systems acceptance testing and commissioning process area 306 (FIG. 3A), which is applicable to for entities that are in an integrator role. In one embodiment, the integrator role may require the utilization of vendors that have been certified by the certification authority 102.

Turning now to FIG. 4B, at decision block 412, a test is conducted to determine whether the designated role corresponds to a service provider role 106. If the role of the requester is a service provider, the certification authority 102 will process the certification requirements for systems maintenance and support process area 308 (FIG. 3A), which is applicable to for entities that are in a service provider role. In one embodiment, the integrator role may require the utilization of vendors and integrators that have been certified by the certification authority 102. At block 420, the routine 400 terminates. Upon the termination of routine 400, the certification authority 102 may store the determined certification requirements, transmit the determined certification requirements, publish the determined certification requirements and the like.

With reference to FIGS. 5A and 5B, a sub-routine 500 for determining process areas requirements for a defined process area will be described. With reference to FIGS. 4A and 4B, sub-routine 500 may be implemented multiple times, such as at block 404, 410, 414 or 420. Illustratively, the certification authority 102 implements an iterative process of examining each process area subgroup for a specified process area. In turn, the certification authority 102 then examines each base practice objective for each of the identified process area subgroups. Still further, the certification authority 102 then examines each of the individual certification requirements for each identified base practice objective.

With reference to FIG. 5A, the certification authority 102 identifies the next process area subgroup for the defined process area at block 502. At block 504, the certification authority 102 selects the next base practice objective. At block 506, the certification authority 102 selects the next certification requirement for the current base practice objective.

At decision block 508, a test is conducted to determine whether the certification level associated with the current certification requirement meets or is less than the certification level specified in the request from the entity. For example, a specified desired level for silver certification would encompass all certification requirements associated with a bronze or silver level of certification. If the current certification requirement meets or is less than the certification level specified in the request, at block 510, the certification requirement is added to the certification scope (e.g., the set of required certification requirements). If not, the current certification requirement may be omitted.

At decision block 510, a test is conducted to determine whether additional certification requirements are identified for the specified base practice objective. If so, the sub-routine 500 returns to block 506 until all the requirements for the current base practice objective have been evaluated or alternatively until one requirement is determined not be required.

Turning to FIG. 5B, once all the certification requirements for the current base practice objective have been satisfied, at decision block 514, a test is conducted to determine whether additional base practice objective are defined for the current process area subgroup. If so, the sub-routine 500 returns to block 504 to process the next base practice objective for the current process area subgroup. Portions of sub-routine 500 then repeat until all the base practice objectives for the current process area subgroup have been evaluated.

At decision block 516, once all the base practice objectives for a current process area subgroup have been evaluated, a test is conducted to determine whether additional process area subgroups remain to be evaluated. If so, the sub-routine 500 returns to block 502 to process the next process area subgroup for the specified process area. Portions of sub-routine 500 then repeat until all the process area subgroups for the specified process area have been evaluated. Upon the completion of the evaluation all process area subgroups (and corresponding base practice objectives and certification requirements), the sub-routine 500 returns the identified certification requirements at block 518.

Turning now to FIGS. 6 and 7, illustrative routines 600, 700 for the evaluation of a set of certification requirements will be described. For illustrative purposes, routines 600, 700 will be described as being implemented generally by the certification authority 102 regardless of whether such implementation may involve multiple components associated with the certification authority. With reference to FIG. 6A, at block 602, the certification authority 102 obtains certification scoping information from the request entity. Illustratively, an entity, such as a potential vendor 104, integrator 106 or service provider 108, sends a certification request to the certification authority 102. Illustratively, the certification information include the identification of the set of certification requirements previously determined by the certification authority (FIGS. 4A and 4B) along with evidence of implementation. The evidence of implementation may vary according to specific certification requirements and will be generally referred to as warrants.

Similar to routine 400, upon receipt of the request, the certification authority 102 processes the request and determines certification compliance for the requesting entity based on the role of the entity and the desired certification level. In the embodiment illustrated in FIGS. 6A and 6B, the certification authority 102 can implement an iterative process to select appropriate certification requirements based on role and certification level. More specifically, at block 604, the certification authority 102 processes certification analysis for the organization process area 302 (FIG. 3A). As previously described, the organization process area may be applicable to all roles. An illustrative sub-routine 700 for processing the requirements according to a specific process area will be described with regard to FIG. 7.

At decision block 606, a test is conducted to determine whether the designated role corresponds to a vendor role 104. If the role of the requester is a vendor, the certification authority 102 will identify certification analysis for each component to be provided by the vendor. Accordingly, the certification authority 102 enters an iterative loop to select a next component at block 608 and process the certification requirements for systems capability process area 304 (FIG. 3A), which is applicable to for entities that are in a vendor role. Blocks 608 and 610 will repeat for multiple components.

At decision block 612, a test is conducted to determine whether the designated role corresponds to an integrator role 106. If the role of the requester is an integrator, the certification authority 102 will process the certification analysis for systems acceptance testing and commissioning process area 306 (FIG. 3A), which is applicable to for entities that are in an integrator role. In one embodiment, the integrator role may require the utilization of vendors that have been certified by the certification authority 102.

Turning now to FIG. 6, at decision block 612, a test is conducted to determine whether the designated role corresponds to a service provider role 106. If the role of the requester is a service provider, the certification authority 102 will process the certification analysis for systems maintenance and support process area 308 (FIG. 3A), which is applicable to for entities that are in a service provider role. In one embodiment, the integrator role may require the utilization of vendors and integrators that have been certified by the certification authority 102. At block 620, the routine 600 terminates. Upon the termination of routine 600, the certification authority 102 may store the determined certification, transmit the determined certification, publish the determined certification and the like. Illustratively, the determined certification can include a determination that certification is complete or incomplete.

With reference to FIG. 7, a sub-routine 700 for determining whether certification requirements for a defined process area will be described. Sub-routine 700 may be implemented multiple times, such as at block 604, 610, 614 or 620. Illustratively, the certification authority 102 implements an iterative process of examining each process area subgroup for a specified process area.

At block 702, the certification authority 102 identifies the next certification requirement for the defined process area. At block 704, the certification authority 102 obtains the warrant information corresponding to the information submitted by the requester that is purportedly evidentiary of satisfaction of the selected system requirement.

At decision block 706, a test is conducted to determine whether the certification requirement has been met. If so, the certification authority 102 designates the certification requirement as satisfied at block 708 and may increment a counter related to a number of certification requirements satisfied. In some embodiments, the certification authority 102 and requesting entity may have any number of supplemental interactions related to an establishment of whether the certification requirement has been implemented.

In some embodiments, the certification authority may allow some portion of the certification requirements to be designated as future implementations. For example, one or more certification requirements may not be able to be satisfied until a minimum number of sales or installations occur. In another example, the certification authority may allow the requester some time period to implement one or more certification requirements. Accordingly, in this embodiment, if at decision block 706 the certification requirement is not satisfied, at decision block 710, a test is conducted to determine whether the certification criteria is associated with time criteria that will allow the certification requirement to be implemented in the future. If so, at block 712, the certification authority 102 designates the certification requirement as a future implementation and may increment a counter related to a number of future implementations.

If the current requirement is not associated with time criteria, at block 714, the certification authority 102 designates the certification requirement as not satisfied and may increment a counter related to a number of failed certification requirements.

At decision block 716, a test is then conducted to determine whether additional certification requirements exist. If so, the sub-routine 700 returns to block 702 to select the next certification requirement. Alternatively, the sub-routine 700 returns the results at block 718.

As discussed with regard to FIG. 2B, once all the certification requirements have been evaluated, the certification authority 102 can utilize multiple threshold to determine whether certification is appropriate and at what level. In one example, the certification authority may utilize a threshold that indicates that maximum number of certification requirements that are designated as not satisfied or a list of certification requirements that must be satisfied. In another example, the certification authority may utilize a threshold that identifies a maximum number of future implementation. In another embodiment, the certification authority may also utilize weighing schemas in which certification requirements are associated with weights according to priorities or importance. In this embodiment, the analysis of the certification would include a determination of an overall score based on average weights of the individual certification requirements or a sum total of the weights of the satisfied certification requirements. Other analysis techniques may also be implemented.

While illustrative embodiments have been disclosed and discussed, one skilled in the relevant art will appreciate that additional or alternative embodiments may be implemented within the spirit and scope of the present disclosure. Additionally, although many embodiments have been indicated as illustrative, one skilled in the relevant art will appreciate that the illustrative embodiments do not need to be combined or implemented together. As such, some illustrative embodiments do not need to be utilized or implemented in accordance with the scope of variations to the present disclosure.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer-readable medium storing the computer executable components, such as a CD-ROM, DVD-ROM, or network interface. Further, the component and/or data can be included in a single device or distributed in any manner. Accordingly, general purpose computing devices may be configured to implement the processes, algorithms and methodology of the present disclosure with the processing and/or execution of the various data and/or components described above. Alternatively, some or all of the methods described herein may alternatively be embodied in specialized computer hardware. In addition, the components referred to herein may be implemented in hardware, software, firmware or a combination thereof.

It should be emphasized that many variations and modifications may be made to the above-described embodiments, the elements of which are to be understood as being among other acceptable examples. All such modifications and variations are intended to be included herein within the scope of this disclosure and protected by the following claims.

APPENDIX A

| Process Area | | | |
|---|---|---|---|
| Categories | PA | BP ID | Base Practice Objective |
| Organizational | PA01: Prepare | BP.01.01 | Requirement recognition and |
| Process Areas | and Inform | | enforcement |
| | Personnel | BP.01.02 | Ensure alignment |
| | | BP.01.03 | Protect sensitive documentation |
| | | BP.01.04 | Background checks |
| | | BP.01.05 | Competent personnel |
| | | BP.01.06 | Confidentiality and user |
| | | | agreements |
| | PA02: Designate | BP.02.01 | Nominate the role |
| | a Security Contact | | |
| | PA03: Specify | BP.03.01 | Standards employed |
| | Base Practices | BP.03.02 | Security certificates |
| System | PA04: Harden | BP.04.01 | Document requirements |
| Capability | the System | BP.04.02 | Manage 3^{rd} party software |
| Process Areas | | BP.04.03 | Conduct 3^{rd} party security |
| | | | architecture reviews |
| | | BP.04.04 | Declaration of trusted interfaces |
| | | BP.04.05 | Strengthen Protocol |
| | PA05: Protect | BP.05.01 | Support anti-virus software |
| | from Malicious | BP.05.02 | Proper installation instructions |
| | Code | BP.05.03 | Virus-free equipment |
| | PA06: Implement | BP.06.01 | Policy documentation |
| | Patch | BP.06.02 | Patch qualification |
| | Management | BP.06.03 | Provide patch list |
| | | BP.06.04 | Prompt patch notification |
| | | BP.06.05 | Audit tools |
| | | BP.06.06 | Patching documentation |
| | PA07: Secure | BP.07.01 | Multiple default passwords |
| | Account | BP.07.02 | Removable default accounts |
| | Management | BP.07.03 | Minimum password strength |
| | | BP.07.04 | Password lifetimes and reuse |
| | | | restrictions |
| | | BP.07.05 | Persistence of special accounts |
| | | BP.07.06 | Role-based access for network |
| | | | devices |
| | | BP.07.07 | Unified account management |
| | | BP.07.08 | Maintain account logs |
| | PA08: Support | BP.08.01 | Backup documentation |
| | Backup/Restore | BP.08.02 | Backup process |
| | PA09: Increase | BP.09.01 | Security monitoring protocols |
| | Network Visibility | BP.09.02 | Management Information Base |
| | PA10: | BP.10.01 | Historian data collection |
| | Standardize | BP.10.02 | Data warehouses |
| | Historian | BP.10.03 | Log and event management |
| | Interfaces | | |
| | PA11: Verify | BP.11.01 | Operator acknowledgement |
| | Operations | BP.11.02 | Automated Operations |
| | PA12: Connect | BP.12.01 | Approved standards |
| | Wirelessly | BP.12.02 | Configuration methods |
| | PA13: Fortify SIS | BP.13.01 | Configuration key switch |
| | Connectivity | BP.13.02 | Third-party assessment |
| | | BP.13.03 | Communications integrity |
| | | BP.13.04 | Layer 3 connections |
| | | BP.13.05 | DCS communications |
| | | BP.13.06 | SIS EWS |
| | PA14: Provide | BP.14.01 | Remote access applications |
| | Remote Access | BP.14.02 | Remote update applications |
| | PA15: Protect | BP.15.01 | Protect data at rest |
| | Data | BP.15.02 | Protect data in transit |
| | | BP.15.03 | Encryption |
| System | PA16: Manage | BP.16.01 | Risk assessment |
| Acceptance | the Deployment | BP.16.02 | Inventory register |
| Testing & | | BP.16.03 | Temporary account removal |
| Commissioning | | BP.16.04 | Network scan |
| Process Areas | | BP.16.05 | Relevant processes |
| | | BP.16.06 | Timely notification |
| | PA17: Harden | BP.17.01 | Hardened system |
| | the System | | demonstration |
| | | BP.17.02 | Firewall use |
| | PA18: Protect | BP.18.01 | Quality definition files |
| | from Malicious | BP.18.02 | General anti-virus policy |
| | Code | BP.18.03 | Portable media procedure |
| | | BP.18.04 | Anti-virus management |
| | | BP.18.05 | Anti-virus demonstration |
| | PA19: Implement | BP.19.01 | Up-to-date systems |
| | Patch | | |
| | Management | | |
| | PA20: Secure | BP.20.01 | Individual accounts |
| | Account | BP.20.02 | Default passwords |
| | Management | BP.20.03 | Minimum password strength |
| | | BP.20.04 | Password lifetimes and reuse |
| | | | restrictions |
| | | BP.20.05 | Persistence of special accounts |
| | | BP.20.06 | Role-based access for network |
| | | | devices |
| | | BP.20.07 | Workstation session lock |
| | PA21: Support | BP.21.01 | Regular backups |
| | Backup/Restore | BP.21.02 | Backup demonstration |
| | PA22: Implement | BP.22.01 | Architecture drawings |
| | the Architecture | BP.22.02 | Network layer separation |
| | | BP.22.03 | Time synchronization |
| | PA23: Connect | BP.23.01 | Service Set Identifier (SSID) |
| | Wirelessly | BP.23.02 | Wireless device maintenance |
| | | BP.23.03 | Safeguarding functions |
| | | BP.23.04 | Secure accounts |
| | | BP.23.05 | Wireless workers and CSAD |
| | | BP.23.06 | Architecture documentation |
| | PA24: Provide | BP.24.01 | Remote access documentation |
| | Remote Access | BP.24.02 | Connection approval and review |
| | PA25: Protect | BP.25.01 | Protect data at rest |
| | Data | BP.25.02 | Protect data in transit |
| | | BP.25.03 | Encryption |
| | | BP.25.04 | Encryption key management |
| | | BP.25.05 | Digital certificate management |
| Maintenance & | PA26: Manage | BP.26.01 | Risk assessment |
| Support Process | the Deployment | BP.26.02 | Inventory register |
| Areas | | BP.26.03 | Temporary account removal |
| | | BP.26.04 | Network scan |
| | | BP.26.05 | Relevant processes |
| | | BP.26.06 | Timely notification |
| | PA27: Harden | BP.27.01 | Harden system demonstration |
| | the Systems | BP.27.02 | Firewall use |
| | PA28: Protect | BP.28.01 | General anti-virus policy |
| | from Malicious | BP.28.02 | Portable media procedure |
| | Code | BP.28.03 | Anti-virus management |
| | PA29: Implement | BP.29.01 | Up-to-date systems |
| | Patch | | |
| | Management | | |
| | PA30: Secure | BP.30.01 | Individual accounts |
| | Account | BP.30.02 | Minimum password strength |
| | Management | BP.30.03 | Password lifetimes and reuse |
| | | | restrictions |
| | | BP.30.04 | Persistence of special accounts |
| | | BP.30.05 | Role-based access for network |
| | | | devices |
| | | BP.30.06 | Workstation session lock |
| | PA31: Support | BP.31.01 | Regular backups |
| | Backup/Restore | BP.31.02 | Backup prior to change event |
| | | BP.31.03 | Backup demonstration |
| | PA32: Implement | BP.32.01 | Architecture drawings |
| | the Architecture | BP.32.02 | Network layer separation |
| | PA33: Connect | BP.33.01 | Service set identifier (SSID) |
| | Wirelessly | BP.33.02 | Wireless device maintenance |
| | | BP.33.03 | Safeguarding functions |
| | | BP.33.04 | Secure accounts |
| | | BP.33.05 | Wireless workers and CSAD |
| | | BP.33.06 | Architecture documentation |
| | PA34: Provide | BP.34.01 | Remote access documentation |
| | Remote Access | BP.34.02 | Connection approval and review |
| | PA35: Protect | BP.35.01 | Protect data at rest |
| | Data | BP.35.02 | Protect data in transit |
| | | BP.35.03 | Encryption |
| | | BP.35.04 | Encryption key management |
| | | BP.35.05 | Digital certificate management |

What is claimed is:

1. A method for managing certifications of entities comprising:
obtaining a request for certification of an entity, wherein the request for certification includes a specification of a role for the entity, the role selected as one of a vendor, an integrator or a service provider and wherein the request for certification includes a specification of a level of certification selected from one of three levels of certification;
obtaining a set of certification requirements, the set of certification requirements organized according to a set of process areas, each process area is applicable to one or more roles;
wherein each process area defines a set of process area subgroups;
wherein each process area subgroup defines one or more base practice objectives; and
wherein each base practice objective defines two or more certification requirements organized by a level of certification, wherein at least two certification requirements correspond to different levels of the three level of certification;
identifying two or more process areas applicable to the request for certification based on the role identified in the request for certification, wherein the identified two or more process areas define a target set of certification requirements;
for each identified process area; iteratively identifying one or more certification requirements based on whether a certification level associated with each of the target set of certification requirements is satisfied by the specification of the level of certification in the request for certification;
providing the identified one or more certification requirements responsive to the request for certification;
obtaining information indicative of certification information corresponding to the identified one or more certification requirements;
analyzing the certification information to identify a number of certification requirements that are indicative of being implemented, a number of certification requirements that may be implemented in the future, and a number of certification requirements that have not been implemented;
comparing the number of certification requirements that are indicative of being implemented, the number of certification requirements that may be implemented in the future, and the number of certification requirements that have not been implemented with one or more thresholds; and
determining certification based on the comparison.

2. The method as recited in claim 1, wherein the set of process areas include at least one process area applicable to all roles.

3. The method as recited in claim 1, wherein the set of process areas include at least one process area applicable to a single role.

4. The method as recited in claim 1, wherein each base process practice objective includes at least one certification requirement for each of the three levels of certification.

5. The method as recited in claim 1, wherein the three levels of certification are hierarchically arranged.

6. The method as recited in claim 5:
wherein a first level of certification requirements corresponds to a minimum number of certification requirements,
wherein a second level of certification requirements corresponds to the minimum number of certification requirements from the first level plus a first additional number of certification requirements, and
wherein a third level of certification requirements corresponds to the minimum number of certification requirements from the first level, the first additional requirements number of certification requirements from the second level and a second additional number of certification requirements.

7. The method as recited in claim 5, wherein each of the three levels has no overlapping certification requirements.

8. The method as recited in claim 1, wherein the one or more thresholds correspond to a maximum number of certification requirements that may be implemented in the future.

9. The method as recited in claim 1, wherein the one or more thresholds correspond to a maximum number of certification requirements that have not been implemented.

10. The method as recited in claim 1, wherein the number of certification requirements that may be implemented in the future are associated with time criteria.

11. The method as recited in claim 1, wherein determining certification based on the comparison includes determining a specified level of certification has been satisfied.

12. The method as recited in claim 1, wherein determining certification based on the comparison includes determining a specified level of certification has not been satisfied.

13. A method for managing certifications of entities comprising:
obtaining a request for certification of an entity, wherein the request for certification includes a specification of a role for the entity, the role selected as one of a set of roles and wherein the request for certification includes a specification of a level of certification selected from a set of levels of certification;
obtaining a set of certification requirements, the set of certification requirements organized according to a set of process areas, each process area is applicable to one or more roles;
wherein each process area defines a set of process area subgroups;
wherein each process area subgroup defines one or more base practice objectives; and
wherein each base practice objective defines certification requirements organized by a level of certification;
identifying process areas applicable to the request for certification based on the role identified in the request for certification, wherein the identified process areas define a target set of certification requirements;
for each identified process area; iteratively identifying one or more certification requirements based on whether a certification level associated with each of the target set of certification requirements is satisfied by the specification of the level of certification in the request for certification;
providing the identified one or more certification requirements responsive to the request for certification.

14. The method as recited in claim 13, wherein the set of process areas include at least one process area applicable to all roles.

15. The method as recited in claim 13, wherein the set of process areas include at least one process area applicable to a single role.

16. The method as recited in claim 13, wherein each base process practice objective includes at least one certification requirement for each of the levels of certification.

17. The method as recited in claim 13, wherein the three levels of certification are hierarchically arranged.

18. The method as recited in claim 13, wherein at least two certification requirements correspond to different levels of the level of certification.

19. A method for managing certifications of entities comprising:
obtaining information indicative of certification information corresponding to a set of identified certification requirements,
wherein the certification requirements were determined by processing a set of certification requirements to a selected role and certification level;
wherein the set of certification requirements are organized according to a set of process areas, each process area is applicable to one or more roles;
wherein each process area defines a set of process area subgroups;
wherein each process area subgroup defines one or more base practice objectives; and
wherein each base practice objective defines two or more certification requirements organized by a level of certification, wherein at least two certification requirements correspond to different levels of the three level of certification;
analyzing the certification information to identify a number of certification requirements that are indicative of being implemented, a number of certification requirements that may be implemented in the future, and a number of certification requirements that have not been implemented;
comparing the number of certification requirements that are indicative of being implemented, the number of certification requirements that may be implemented in the future, and the number of certification requirements that have not been implemented with one or more thresholds; and
determining certification based on the comparison.

20. The method as recited in claim 19, wherein the three levels of certification are hierarchically arranged.

21. The method as recited in claim 19, wherein the one or more thresholds correspond to a maximum number of certification requirements that may be implemented in the future.

22. The method as recited in claim 19, wherein the one or more thresholds correspond to a maximum number of certification requirements that have not been implemented.

23. The method as recited in claim 19, wherein the number of certification requirements that may be implemented in the future are associated with time criteria.

24. The method as recited in claim 19, wherein determining certification based on the comparison includes determining a specified level of certification has been satisfied.

25. The method as recited in claim 19, wherein determining certification based on the comparison includes determining a specified level of certification has not been satisfied.
